(19) United States
(12) Patent Application Publication
(10) Pub. No.: US 2026/0042327 A1
(43) Pub. Date: Feb. 12, 2026

(54) Detachable trailer hitch device for a motor vehicle

(71) Applicant: BOS GmbH & Co. KG, Ostfildern (DE)

(72) Inventors: Waldemar STAPLER, Böblingen (DE); Thomas FISCHER, Tübingen (DE)

(21) Appl. No.: 18/798,941

(22) Filed: Aug. 9, 2024

(51) Int. Cl. B60D 1/52; B60D 1/06; B60D 1/58

(52) U.S. Cl. CPC B60D 1/52; B60D 1/06; B60D 1/58

(57) ABSTRACT

Detachable trailer hitch device for a vehicle having a hollow carrier profile for insertion into a profile receptacle fixed to the vehicle, a hitch ball arranged on the carrier profile for coupling to a trailer hitch, and a locking element configured for releasably locking the carrier profile to the profile receptacle. The locking element is mounted on the carrier profile and is movable relative thereto between a release position wherein the locking element is shifted into the carrier profile and a locking position wherein the locking element protrudes out of the hollow carrier profile. Also provided is an actuating apparatus having an actuating element operatively connected to the locking element, mounted on the carrier profile and manually movable relative to the carrier profile. Via a movement of the actuating element, the locking element is movable between the release position and the locking position.

The invention relates to a detachable trailer hitch device for a motor vehicle.

Trailer hitch devices are usually used in pick-up trucks and leisure vehicles in order to fasten a trailer to the vehicle.

Trailer hitch devices known from the prior art comprise a hollow carrier profile, a hitch ball, and at least one locking element. The hollow carrier profile is configured to be axially inserted into a profile receptacle fixedly arranged on the rear of the vehicle. The hitch ball is rigidly connected to the hollow carrier profile and is configured for coupling to a trailer hitch. The locking element serves to releasably lock the hollow carrier profile to the profile receptacle fixed to the vehicle.

US 2009/0115165 A1 discloses a trailer hitch device in which the locking element is in the form of a cross bolt. To lock the hollow carrier profile to the profile receptacle, the cross bolt is manually pushed through holes in the profile receptacle and the hollow carrier profile provided for this purpose transversely to the longitudinal axis of the hollow carrier profile and is secured with a splint.

US 2011/0089669 A1 discloses a trailer hitch device which, in addition to the locking by a cross bolt, comprises a mechanism which allows for interlocking pre-loading between the hollow carrier profile and the profile receptacle, in order to avoid vibrations and associated noises and damage.

It is an object of the invention to provide a detachable trailer hitch device of the type mentioned at the outset which provides advantages over the prior art.

This problem is solved by providing a detachable trailer hitch device having the features of claim 1. Advantageous embodiments are defined in the dependent claims. The wording of the claims is incorporated into the subject matter of the description by reference.

The trailer hitch device according to the invention comprises a hollow carrier profile, a hitch ball, at least one locking element, and an actuating apparatus comprising an actuating element. The hollow carrier profile extends longitudinally along a longitudinal axis and is configured to be axially inserted into a profile receptacle fixed to the vehicle. The hitch ball is arranged on the hollow carrier profile and is configured for coupling to a trailer hitch. The at least one locking element is configured to releasably lock the hollow carrier profile to the profile receptacle fixed to the vehicle. The at least one locking element is mounted on the hollow carrier profile and is movable relative to the hollow carrier profile between a release position and a locking position. In the release position, the at least one locking element is shifted into the hollow carrier profile transversely to the longitudinal axis. In the locking position, the at least one locking element protrudes out of the hollow carrier profile transversely to the longitudinal axis. The actuating element is operatively connected to the locking element, is mounted on the hollow carrier profile, and is manually movable relative to the hollow carrier profile. By means of a manual movement of the actuating element, the at least one locking element is movable between the release position and the locking position. The trailer hitch device according to the invention allows for simplified locking and unlocking. This locking and unlocking takes place by manually actuating the actuating element. In comparison with known solutions, there is in particular no need to manually insert a cross bolt and secure it with a splint. In the release position, the at least one locking element is shifted into the hollow carrier profile. As a result, the hollow carrier profile can be axially inserted into the profile receptacle without being impaired by the locking element. In the locking position, the locking element protrudes out of the hollow carrier profile transversely to the longitudinal axis, in order to engage in a complementary locking opening in the profile receptacle. The locking element and said complementary locking opening can each have any design suitable for the present purpose. In the locking position, the locking element interlockingly engages in the locking opening. The interlocking takes effect at least along the longitudinal axis. The locking element is movable, for example translationally and/or rotationally, between the release position and the locking position in different ways in different embodiments. The actuating element is manually movable, for example translationally and/or rotationally, in different ways in different embodiments. In a preferred embodiment, the locking element is translationally movable and the actuating element is rotationally movable. In the release position of the locking element, the actuating element assumes a first position. In the locking position, the actuating element assumes a second position. In one embodiment, a movement of the actuating element from the first position into the second position causes the locking element to move from the release position into the locking position. In another embodiment, a movement of the actuating element from the second position into the first position causes the locking element to move from the locking position into the release position. In another embodiment, the actuating element only allows a movement from the locking position into the release position. In another embodiment, the actuating element only allows a movement from the release position into the locking position. In another embodiment, the actuating element allows a movement both from the release position into the locking position and vice versa.

In one embodiment of the invention, the trailer hitch device further comprises at least one pre-loading element. The at least one pre-loading element is operatively connected to the locking element and/or the actuating apparatus. The pre-loading element causes the locking element to be pre-loaded, i.e. biased, toward the locking position. The pre-loading element results in simplified locking, since there is no need to manually move the actuating element to shift the locking element into the locking position. Instead, the locking element is moved into the locking position by means of the pre-loading element, or more precisely, by means of its pre-loading. The pre-loading element can be designed in any manner suitable for the present purpose, for example as a spring, in particular a cylindrical helical spring, a spiral spring, a leaf spring, a torsion spring, or the like. In one embodiment, a movement of the actuating element from the second position into the first position causes the pre-loading element to be pre-loaded. The pre-loading element is pre-loaded in the release position and is not loaded, or is pre-loaded to a lesser extent, in the locking position. The pre-loading element is at least indirectly connected to the locking element so as to generate its pre-loading. In one embodiment, the pre-loading element acts directly on the locking element. In another embodiment, the pre-loading element acts directly on the actuating element and/or another component of the actuating apparatus.

In another embodiment of the invention, the trailer hitch device comprises an arresting apparatus, by means of which the locking element is releasably arrested in the release position and/or the locking position. Releasable arresting in the release position allows the hollow carrier profile to be inserted into the profile receptacle in a simplified manner, since undesired shifting into the locking position is counteracted. This is particularly advantageous when the trailer hitch device comprises a pre-loading element according to the preceding embodiment. Provided that the releasable arresting is acting in the locking position, it is possible to particularly securely lock the hollow carrier profile to the profile receptacle. The arresting apparatus is designed differently in different embodiments and can be configured for interlocking and/or frictional arresting.

In another embodiment of the invention, the arresting apparatus comprises a first arresting element, which is operatively connected to the locking element and/or the actuating apparatus in the release position of the locking element, wherein the first arresting element causes the locking element to be releasably arrested in the release position. For releasably arresting the locking element in the release position, the first arresting element can directly interact with the locking element, the actuating element, and/or another component of the actuating apparatus. The releasable arresting can be brought about by an interlocking fit and/or a frictional fit. The first arresting element is mounted on the hollow carrier profile and is movable relative to the hollow carrier profile between a first position and a second position. The releasable arresting is available in the first position. In the second position, the arresting is released. The first arresting element is movable, for example translationally and/or rotationally, between its first position and its second position in different ways in different embodiments.

In another embodiment of the invention, the first arresting element releasably interlockingly interacts with a first arresting portion of the actuating element in the release position. In this embodiment of the invention, the movability of the locking element is indirectly arrested in the release position by the first arresting element forming a releasable interlocking fit with the actuating element. For this purpose, the actuating element comprises a first arresting portion, which is configured to releasably interlockingly interact with the first arresting element. The first arresting element and the first arresting portion can be designed in any manner suitable for the present purpose. In a preferred embodiment, the actuating element is a rotary actuating element, the first arresting portion is a hole, and the first arresting element is a bolt. In the first position of the first arresting element and therefore also in the first position of the actuating element, the bolt engages in the hole in the axial direction and brings about an interlocking fit in the rotational direction of the rotary actuating element.

In another embodiment of the invention, the arresting apparatus comprises a trigger element, which is operatively connected to the first arresting element and is mounted on the hollow carrier profile so as to be movable between a first position and a second position, wherein the trigger element assumes its first position in the release position of the at least one locking element, and wherein a movement of the trigger element from its first position into its second position causes the arresting of the first arresting element to be released. The trigger element allows the arresting caused by the first arresting element to be released in a simplified manner. In one embodiment, the trigger element is manually movable from its first position into its second position. In another embodiment, the trigger element is movable from its first position into its second position under the action of the profile receptacle when inserting the hollow carrier profile into the profile receptacle. The trigger element is movable, for example translationally and/or rotationally, in different ways in different embodiments.

In another embodiment of the invention, the trigger element is movable from the first position into the second position under the action of the profile receptacle by means of axially inserting the hollow carrier profile into the profile receptacle. In this embodiment, there is no need to manually actuate the trigger element to release the arresting of the first arresting element. This allows the operation of the trailer hitch device to be significantly simplified and allows for considerably simplified locking. In one embodiment, the trigger element is configured to mechanically interact with the profile receptacle, for example by the trigger element comprising a contact surface which is contacted by the profile receptacle when inserting the hollow carrier profile in order to move the trigger element from the first position into the second position. In another embodiment of the invention, the trigger element interacts magnetically with the profile receptacle.

In another embodiment of the invention, the trigger element protrudes out of the hollow carrier profile transversely to the longitudinal axis in its first position and is shifted into the hollow carrier profile in its second position. Preferably, the trigger element comprises a contact surface which is configured to interact with the profile receptacle.

In another embodiment of the invention, the arresting apparatus comprises a second arresting element, which is operatively connected to the locking element and/or the actuating apparatus in the locking position of the locking element, wherein the second arresting element causes the locking element to be releasably arrested in the locking position. The second arresting element counteracts an undesired movement of the locking element from the locking position into the release position. For this purpose, the second arresting element can directly interact with the locking element, the actuating element, and/or another component of the actuating apparatus. The releasable arresting in the locking position can be brought about by an interlocking fit and/or a frictional fit.

In another embodiment of the invention, the second arresting element is formed by a portion of the hollow carrier profile which releasably interlockingly interacts with a second arresting portion of the actuating element in the locking position. In this embodiment, the second arresting element is formed by the hollow carrier profile itself, or more precisely, said portion, and therefore is fixed relative to the hollow carrier profile. This results in a simplified structure of the arresting apparatus. The portion of the hollow carrier profile that forms the second arresting element releasably interlockingly interacts with the second arresting portion in the locking position and thus in the second position of the actuating element. The second arresting portion is movable relative to the portion of the hollow carrier profile in order to release the interlocking fit. This movement is preferably a movement that is separate and/or different from the actual actuating movement of the actuating element. Provided that the actuating element is a rotary actuating element, the interlocking fit can for example be released by an axial movement of the rotary actuating element along the longitudinal axis.

In another embodiment of the invention, the actuating apparatus comprises a transmission, which connects the actuating element to the locking element for the transmission of movement. The transmission provides various advantages. First of all, the transmission allows the forces and/or torques that are manually applied to the actuating element to be intensified. In addition, the transmission allows the movement of the actuating element to be converted into a different type of movement of the locking element. For example, a translational movement of the actuating element can be converted into a rotational movement of the locking element or vice versa. The transmission can have a wide range of designs and, for example, can be constructed as a gear transmission, in particular a gear train, a flexible drive, a screw drivetrain, or the like. Mixed designs are also conceivable and possible. For example, the transmission can comprise a gear stage in combination with a flexible intermediate link stage and/or a threaded stage.

In another embodiment of the invention, the transmission is configured to convert a rotational movement of the actuating element into a translational movement of the locking element. This embodiment of the invention provides various advantages. The rotational movability of the actuating element between its first position and its second position in particular results in ergonomic advantages. In addition, the rotational movability of the actuating element can be implemented in structural terms in a small installation space using simple means.

In another embodiment of the invention, the transmission comprises a gear train and/or a screw drivetrain. In one embodiment, the gear train comprises at least one pinion and at least one rack interlocked with the pinion. In one embodiment, the pinion is allocated to a transmission input and therefore to the actuating element and the rack is allocated to a transmission output and therefore to the locking element. In another embodiment, this allocation is reversed. The screw drivetrain preferably comprises at least one threaded spindle and at least one threaded nut screwed to the threaded spindle. In one embodiment, the threaded spindle is allocated to a transmission input and therefore to the actuating element and the threaded nut is allocated to the transmission output and therefore to the locking element. In another embodiment, this allocation is reversed.

In another embodiment of the invention, the actuating element is a rotary actuating element, which is manually rotatably movable relative to the hollow carrier profile. In one embodiment, the rotary actuating element is manually rotatably movable about the longitudinal axis of the hollow carrier profile, preferably coaxially with the longitudinal axis. In another embodiment, the rotary actuating element is rotatably movable about a rotational axis that is oriented transversely to the longitudinal axis.

In another embodiment of the invention, the rotary actuating element is arranged on an end face of the hollow carrier profile and is rotatably movable about its longitudinal axis. By arranging the rotary actuating element on the end face of the hollow carrier profile, a compact structure and simplified operation can be achieved. When the trailer hitch device is mounted, the end face of the hollow carrier profile faces away from the profile receptacle, i.e. points toward the rear in the longitudinal vehicle direction. Therefore, the rotary actuating element arranged on the end face is generally easily accessible.

In another embodiment of the invention, an outer circumference of the rotary actuating element is moved into the end face of the hollow carrier profile along the longitudinal axis in the locking position and interlockingly abuts an inner circumference of the end face so as to rotate about the longitudinal axis, wherein the rotary actuating element is moved out of the end-face opening along the longitudinal axis in the release position. In the release position, the inner circumference and the outer circumference are axially moved away from one another along the longitudinal axis, as a result of which the interlocking fit rotationally acting about the longitudinal axis is removed. In this embodiment of the invention, the outer circumference of the rotary actuating element forms a second arresting portion according to the preceding disclosure. The inner circumference of the end face forms a second arresting element according to the preceding disclosure. The rotational interlocking fit counteracts a rotation of the rotary actuating element and therefore forms releasable arresting.

In another embodiment of the invention, the locking element is a locking bolt, which is translationally movable relative to the hollow carrier profile. The locking bolt is configured to interlockingly engage in a complementary locking opening in the profile receptacle. Preferably, the locking bolt has a circular hollow or solid cross section. The locking bolt extends longitudinally transversely to the longitudinal axis of the hollow carrier profile, preferably in parallel with a transverse axis of the hollow carrier profile. Preferably, the locking bolt is translationally movable in parallel with the transverse axis between the locking position and the release position.

In another embodiment of the invention, two locking elements are provided, which are arranged on opposite longitudinal sides of the hollow carrier profile and are movable in opposite directions to one another. In comparison with embodiments having just one single locking element, this embodiment allows for particularly reliable locking. Preferably, the two locking elements are each constructed as locking bolts according to the preceding embodiment. The two locking elements are movable between their respective locking and release positions preferably synchronously, but in opposite directions to one another, by means of the actuating element.

The invention also relates to a motor vehicle, comprising a profile receptacle fixedly arranged on the rear of the vehicle and comprising a detachable trailer hitch device according to the preceding disclosure. Preferably, the motor vehicle is a pick-up truck.

Further advantages and features of the invention will become clear from the claims and from the following description of preferred exemplary embodiments of the invention, which are set out with reference to the drawings, in which:

FIG. 1 is a schematic side view of an embodiment of a detachable trailer hitch device according to the invention, which is releasably locked to a profile receptacle fixed to the vehicle,

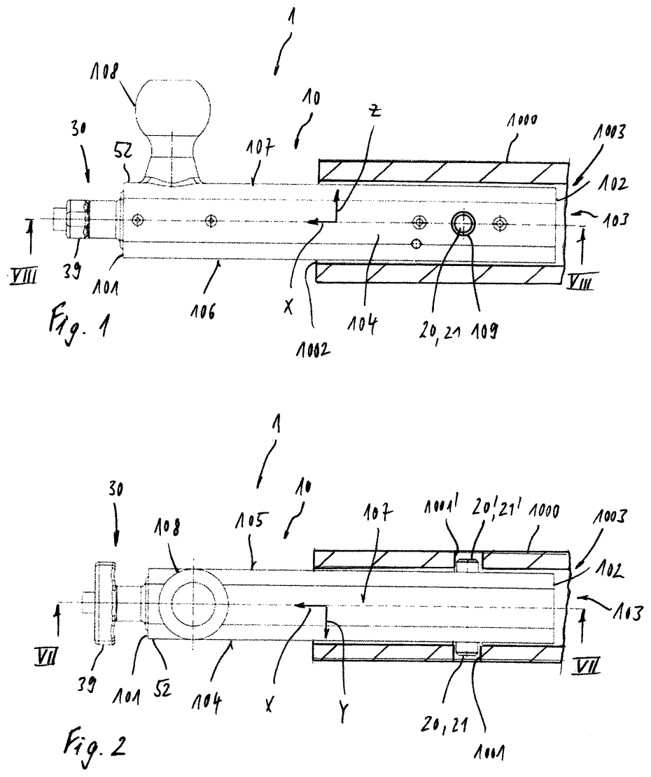

FIG. 2 is a schematic plan view of the trailer hitch device according to FIG. 1 together with the profile receptacle fixed to the vehicle,

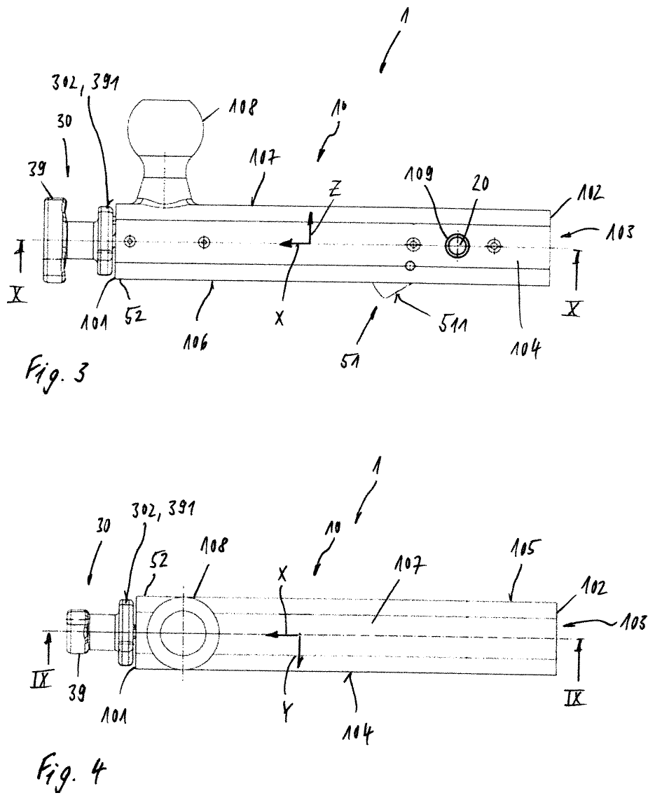

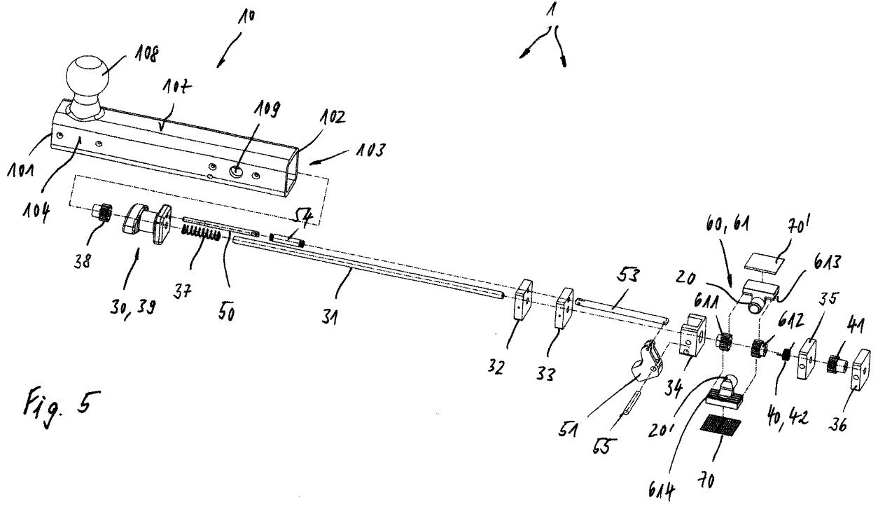

FIGS. 3 and 4 are a schematic side view (FIG. 3) and a schematic plan view (FIG. 4) of the trailer hitch device according to FIGS. 1 and 2 in a state in which it is detached from the profile receptacle,

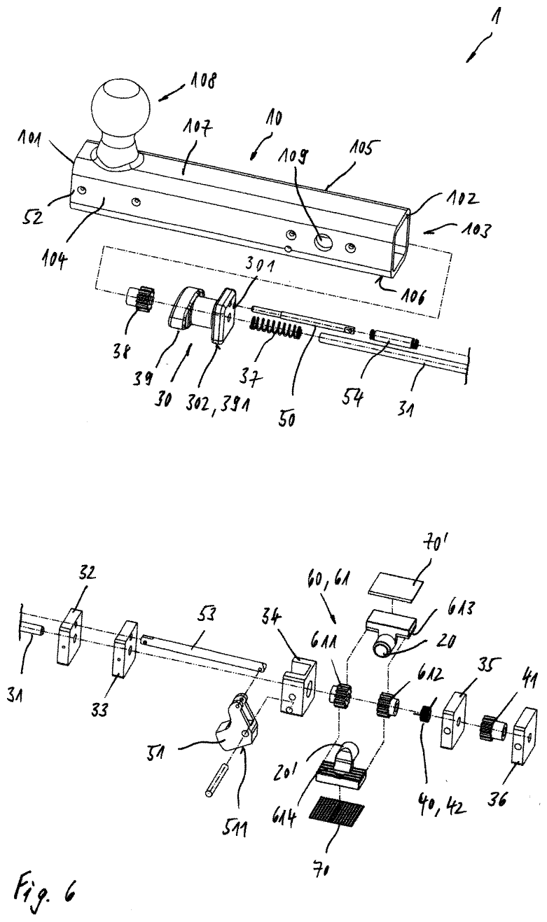

FIG. 5 is a perspective exploded view of the trailer hitch device according to FIG. 1 to 4,

FIG. 6 is another exploded view, which is enlarged compared with FIG. 5,

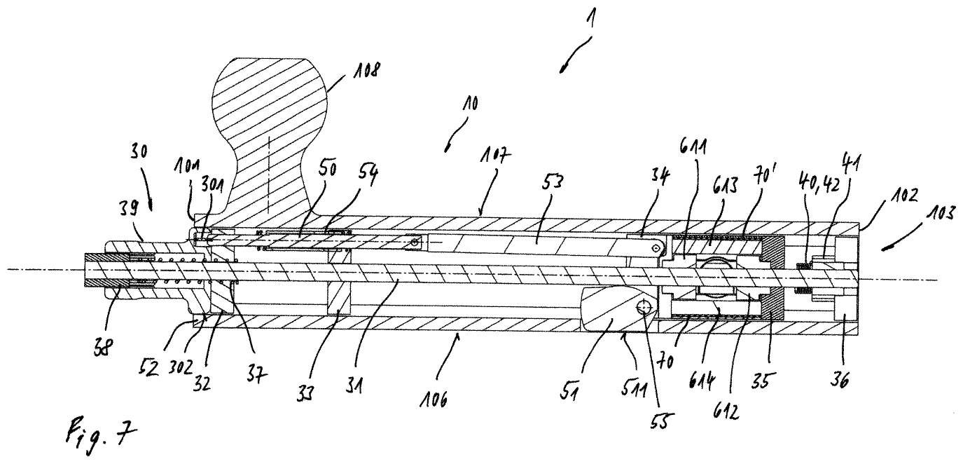

FIGS. 7 and 8 are a vertical longitudinal section along a sectional line VII-VII according to FIG. 2 (FIG. 7) and a horizontal longitudinal section along a sectional line VIII-VIII according to FIG. 1 (FIG. 8) of the trailer hitch device according to FIG. 1 to 6, the trailer hitch device being shown in a locking position,

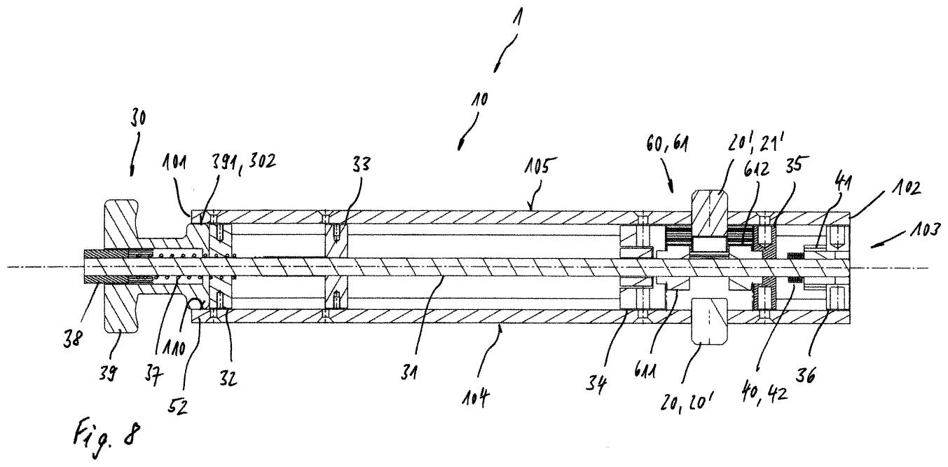

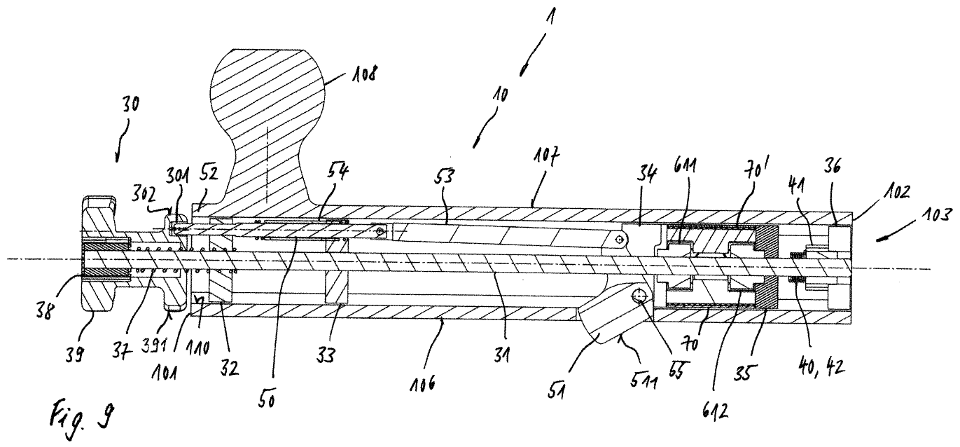

FIGS. 9 and 10 are a vertical longitudinal section along a sectional line IX-IX according to FIG. 4 (FIG. 9) and a horizontal longitudinal section along a sectional line X-X according to FIG. 3 (FIG. 10) of the trailer hitch device according to FIG. 1 to 8, the trailer hitch device assuming a release position,

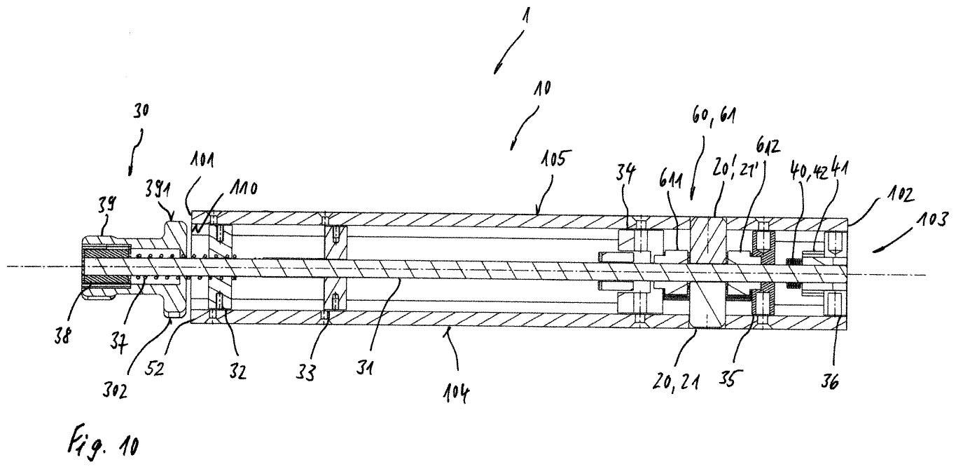

FIGS. 11 and 12 are schematic cross sections through the trailer hitch device according to FIG. 1 to 10, the cross sections being arranged at the axial level of a transmission and showing the release position (FIG. 11) as well as the locking position (FIG. 12),

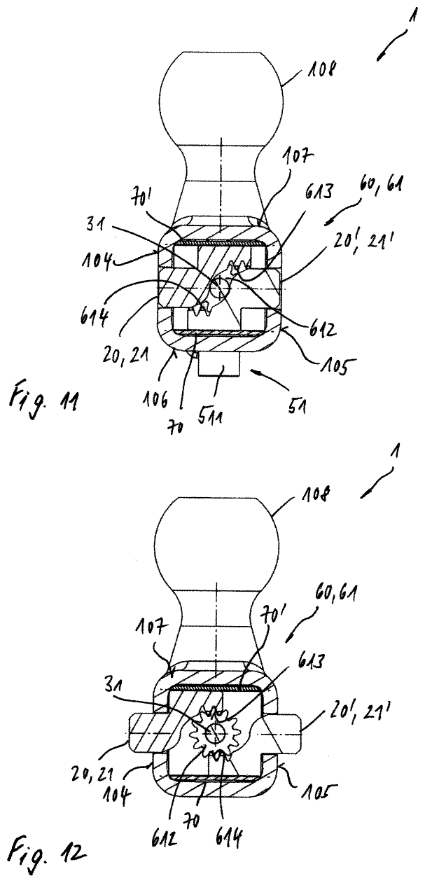

FIGS. 13 and 14 are an axially divided horizontal longitudinal section (FIG. 13) and a vertical longitudinal section (FIG. 14) of the trailer hitch device having one variant of the transmission, and

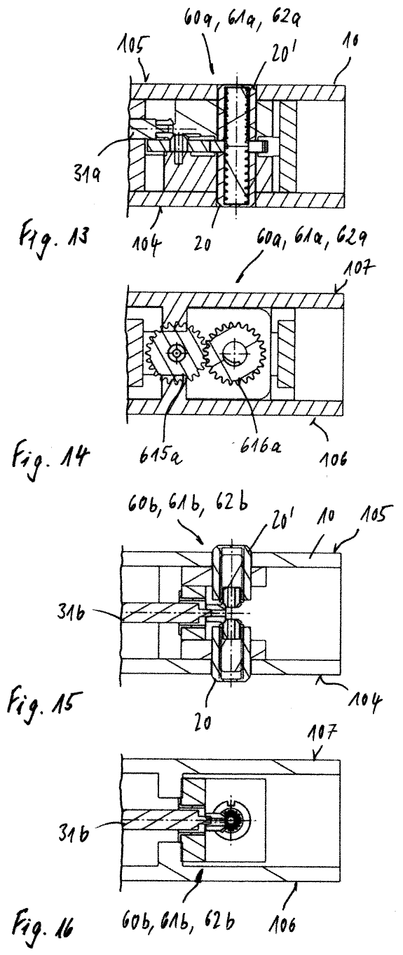

FIGS. 15 and 16 are views according to FIGS. 13 and 14 of the trailer hitch device having another transmission variant.

According to FIG. 1 to 12, a trailer hitch device 1 is provided for detachable mounting on a profile receptacle 1000 fixed to the vehicle (see FIGS. 1 and 2). The profile receptacle 1000 is rigidly mounted on the rear of a vehicle that is otherwise not shown in greater detail, which is a pick-up truck in the present case.

The trailer hitch device 1 comprises a carrier profile 10, a hitch ball 108, at least one locking element 20, and an actuating apparatus comprising an actuating element 30.

The hollow carrier profile 10 extends longitudinally along a longitudinal axis X and is configured to be axially inserted into said profile receptacle 1000. In this case, an axially inserted state is shown in FIGS. 1 and 2.

The hitch ball 108 is arranged on the hollow carrier profile 10 and is configured for coupling to a trailer hitch. In the embodiment shown, the hitch ball 108 is rigidly connected, and specifically welded, to the hollow carrier profile 10. In an embodiment that is not shown in the drawings, the hitch ball 108 is detachably fastened to the hollow carrier profile 10.

The at least one locking element 20 is configured to releasably lock the hollow carrier profile 10 to the profile receptacle 1000 fixed to the vehicle. The at least one locking element 20 is mounted on the hollow carrier profile 10 and is movable relative to the hollow carrier profile 10 between a release position (FIGS. 3, 4, 9, 10, and 11) and a locking position (FIGS. 1, 2, 7, 8, and 12). In the release position, the at least one locking element 20 is shifted into the hollow carrier profile 10 transversely to the longitudinal axis X. In the locking position, the at least one locking element 20 is moved out of the hollow carrier profile 10 and/or protrudes from the hollow carrier profile 10 transversely to the longitudinal axis X. In the embodiment shown, the at least one locking element 20 is movable in parallel with a transverse axis Y of the hollow carrier profile 10 oriented orthogonally to the longitudinal axis X. In the locking position, the at least one locking element 20 interlockingly interacts with a complementary locking opening 1001 in the profile receptacle 1000 (FIG. 2). The interlocking takes effect at least along the longitudinal axis X. In the release position, the at least one locking element 20 is pulled out of the locking opening 1001 and is shifted into the hollow carrier profile 10, as a result of which the axial movability of the hollow carrier profile 10 relative to the profile receptacle 1000 is enabled.

The actuating element 30 is operatively connected to the at least one locking element 20, is mounted on the hollow carrier profile 10, and is manually movable relative to the hollow carrier profile 10. A manual movement of the actuating element 30 causes the at least one locking element 20 to move between the release position and the locking position.

In the embodiment shown, the at least one locking element 20 is releasably arrested in the release position and is pre-loaded toward the locking position, the arresting being automatically released when the hollow carrier profile 10 is inserted into the profile receptacle 1000. In an embodiment that is not shown in the drawings, this kind of pre-loading, arresting, and/or automatic releasing of the arresting is not provided. These functions are therefore considered to be optional.

In the embodiment shown, the hollow carrier profile 10 extends longitudinally along the longitudinal axis X between a first end face 101 and a second end face 102 and comprises a cavity 103 that is continuous between the two end faces 101, 102 and can also be referred to as a hollow cross section. In the embodiment shown, the hollow carrier profile 10 is a hollow square profile. The profile receptacle 1000 is designed to be complementary to the hollow carrier profile 10 and comprises a receiving cutout 1003, which is designed to be complementary to the hollow carrier profile 10 to be received. The hollow carrier profile 10 extends along the transverse axis Y between opposite longitudinal sides 104, 105, which can also be referred to as the left-hand longitudinal side 104 and the right-hand longitudinal side 105. The hollow carrier profile 10 extends along a vertical axis Z, which is oriented orthogonally to the two other axes X, Y, between an underside 106 and a top side 107. The hitch ball 108 is arranged in the region of the first end face 101 on the top side 107. The hollow carrier profile 10 also comprises at least one orifice 109, through which the at least one locking element 20 protrudes out laterally in the locking position.

In the embodiment shown, the trailer hitch device 1 comprises two locking elements 20, 20′. The two locking elements are arranged on opposite longitudinal sides 104, 105 and can also be referred to as the left-hand locking element 20 and the right-hand locking element 20′. In an embodiment that is not shown in the drawings, just one single locking element is provided. In other embodiments, more than two locking elements are provided, for example three, four, or more than four locking elements. In the locking position, the left-hand locking element 20 engages in the above-mentioned (left-hand) locking opening 1001. The right-hand locking element 20′ engages in another locking opening 1001′, which can also be referred to as the right-hand locking opening 1001′. In the embodiment shown, the two locking elements 20, 20′ are movable between the locking position and the release position in opposite directions to one another. In relation to the drawing plane in FIG. 2, the left-hand locking element 20 moves upward during unlocking and the right-hand locking element 20′ moves downward. In relation to the longitudinal axis X, both locking elements 20, 20′ move laterally inward during unlocking and laterally outward during locking.

In the embodiment shown, the locking elements 20, 20′ are each designed as locking bolts 21, 21′. The locking bolts 21, 21′ are each translationally movable between the locking position and the release position. In the present case, the movement takes place in parallel with the transverse axis Y. In an embodiment that is not shown in the drawings, the locking bolts are arranged on the top side and the underside, with movability being provided in parallel with the vertical axis Z.

In the embodiment shown, the actuating element 30 is a rotary actuating element 39, which is manually rotatably movable relative to the hollow carrier profile 10. In the present case, the rotary actuating element 39 is arranged on the first end face 101. In addition, the rotary actuating element 39 is rotatably movable about the longitudinal axis X. In the present case, the rotational movement takes place coaxially with the longitudinal axis X.

The rotary actuating element 39 is operatively connected to the locking bolts 21, 21′ in a manner described in greater detail below. For the purpose of converting the rotational movement of the rotary actuating element 39 into the linear movement of the locking bolts 21, 21′, the actuating apparatus comprises a transmission 60, which is described in greater detail in the following.

In the release position of the locking bolts 21, 21′, the rotary actuating element 39 assumes a first position (see FIGS. 3, 4, 9, 10, and 11). In the locking position, the rotary actuating element 39 assumes a second position (see FIGS. 1, 2, 7, 8, and 12).

In the embodiment shown, the actuating apparatus comprises a shaft 31, which is connected to the rotary actuating element 39 for conjoint rotation at one end and acts on the locking bolts 21, 21′ via the transmission 60, which is described in greater detail below. The shaft 31 extends longitudinally within the hollow carrier profile 10 and is mounted on bearing blocks 32, 33, 34, 35, 36, which are each fastened in the hollow carrier profile 10. The bearing blocks 32 to 36 are also referred to in the following as the first bearing block 32, the second bearing block 33, the third bearing block 34, the fourth bearing block 35, and the fifth bearing block 36.

In the embodiment shown, the transmission 60 is a gear train 61 comprising pinions 611, 612 and racks 613, 614. The pinions 611, 612 are each fixed to the shaft 31 for conjoint rotation. The racks 613, 614 are each rigidly connected to one of the locking bolts 21, 21′. The two pinions 611, 612 can also be referred to as the first pinion 611 and the second pinion 612. The two pinions 611, 612 are mounted along the longitudinal axis X between the third bearing block 34 and the fourth bearing block 35. According to their arrangement in relation to the vertical axis Z, the two racks 613, 614 can also be referred to as the upper rack 613 and the lower rack 614. The upper rack 613 is rigidly connected to the left-hand locking bolt 21. The lower rack 614 is rigidly connected to the right-hand locking bolt 21′. The pinions 611, 612 rotate together with the shaft 31 and therefore also together with the rotary actuating element 39 about the longitudinal axis X. The racks 613, 614 are linearly movable in parallel with the transverse axis Y together with the locking bolts 21, 21′.

A clockwise rotation of the rotary actuating element 39 moves the locking bolts 21, 21′ toward the locking position. A counterclockwise rotation moves the locking bolts 21, 21′ toward the release position.

In the embodiment shown, the racks 613, 614 are each supported on the hollow carrier profile 10 so as to be slidably movable. To reduce friction, sliding elements 70, 70′ are provided (see in particular FIGS. 11 and 12), which are each arranged along the vertical axis Z between the rack 613, 614 in question and the hollow carrier profile 10.

In the embodiment shown, the optional pre-loading toward the locking position is brought about by means of a pre-loading element 40. In the present case, the pre-loading element 40 is a leg spring 42, which is connected to the shaft 31 for torque transmission. The leg spring 42 acts on the locking bolts 21, 21′ via the shaft 31 and the transmission 60.

In the embodiment shown, the leg spring 42 is fixed to another pinion 41, which is connected to the shaft 31 for conjoint rotation and is mounted on the fifth bearing block 36.

The leg spring 42 is resiliently loaded in the release position and is not loaded, or is resiliently loaded to a lesser extent, in the locking position. The leg spring 42 is pre-loaded by a rotation of the rotary actuating element 39. By means of this pre-loading, the hollow carrier profile 10 can be inserted into the profile receptacle 1000 and automatically locked in the retracted state of the locking bolts 21, 21′, i.e. in the release position. When the locking bolts 21, 21′ reach the locking openings 1001, 1001′ when being axially inserted into the receiving cutout 1003, they automatically move into the locking position owing to the pre-loading.

In the embodiment shown, the optional arresting apparatus comprises a first arresting element 50, which causes the locking bolts 21, 21′ to be releasably arrested in the release position (see in particular FIG. 9). In the present case, for the purposes of arresting, the first arresting element 50 interlockingly interacts with the rotary actuating element 39. The first arresting element 50 causes the rotary actuating element 39 to be releasably arrested in its first position. By releasably arresting the rotary actuating element 39, the locking bolts 21, 21′ are indirectly arrested in their release position.

In the embodiment shown, the arresting element 50 is a pin, which extends longitudinally within the hollow carrier profile 10 and is translationally movable relative thereto. In the release position, the first arresting element 50 assumes a first position. In this first position, the arresting element 50 interacts with a first arresting portion 301 of the rotary actuating element 39 provided for this purpose. In the present case, the first arresting portion 301 is a hole, into which the arresting element 50 is axially inserted for the purposes of arresting. In the locking position (see FIG. 7), the first arresting element 50 assumes a second position. In this second position, the arresting element 50 is axially retracted relative to the first arresting portion 301. In the present case, the first arresting element 50 is mounted on the first bearing block 32 and the second bearing block 33 so as to be linearly movable along the longitudinal axis X.

In the embodiment shown, the arresting apparatus comprises a trigger element 51, which is operatively connected to the first arresting element 50. The trigger element 51 is mounted on the hollow carrier profile 10 and can be shifted relative thereto between a first position and a second position. In the release position, the trigger element 51 assumes its first position (see FIG. 9). In the locking position, the trigger element 51 assumes its second position (see FIG. 7). The trigger element 51 is mounted on the hollow carrier profile 10 so as to be pivotally movable about a pivot axis 55. In the present case, the pivot axis 55 extends longitudinally in parallel with the transverse axis Y. The trigger element 51 protrudes out of the hollow carrier profile 10 transversely to the longitudinal axis X in its first position. The trigger element 51 is shifted into the hollow carrier profile 10 transversely to the longitudinal axis X in its second position.

In the present case, the trigger element 51 is connected to the first arresting element 50 by means of a coupling rod 53. The coupling rod 53 extends longitudinally in the hollow carrier profile 10 and is connected in a hinged manner to the first arresting element 50 at one end and is connected in a hinged manner to the trigger element 51 at the other end.

In the embodiment shown, the arresting apparatus also comprises an arresting spring 54, which is operatively connected to the first arresting element 50 and thus also to the trigger element 51. The arresting spring 54 extends longitudinally in the hollow carrier profile 10 and causes the first arresting element 50 and the trigger element 51 to be resiliently pre-loaded into the relevant first position.

In the embodiment shown, the trigger element 51 is configured to be automatically shifted from its first position into its second position when inserting the hollow carrier profile 10 into the profile receptacle 1000 in order to release the arresting of the first arresting element 50. In other words, the arresting in the release position is released automatically, and thus without any assistance from a user, when inserting the hollow carrier profile 10 into the profile receptacle 1000.

For the purposes of interacting with the profile receptacle 1000, the trigger element 51 comprises a contact surface 511, which runs against a leading edge 1002 (see FIG. 1) of the profile receptacle 1000 when inserting the hollow carrier profile 10. Under the action of the leading edge 1002, the trigger element 51 is pushed into the hollow carrier profile 10 in the clockwise direction about the pivot axis 55 starting from its first position (FIG. 9). As a result, the coupling rod 53 is pulled toward the second end face 102. The coupling rod 53 pulls the first arresting element out of the first arresting portion 301 at the end face, as a result of which the rotational movability of the rotary actuating element 39 is enabled.

In the embodiment shown, the arresting apparatus also comprises a second arresting element 52, which causes the locking bolts 21, 21′ to be releasably arrested in the locking position (see FIGS. 7 and 8). In the present case, the second arresting element 52 is formed by a portion of the hollow carrier profile 10, or more precisely, by its first end face 101. The first end face 101 releasably interlockingly interacts with a second arresting portion 302 of the rotary actuating element 39 in the locking position.

In the embodiment shown, the second arresting portion 302 is formed by an outer circumference 391 of the rotary actuating element 39, which releasably interlockingly interacts with an inner circumference 110 of the first end face 101 for the purposes of arresting. In the locking position and thus in the second position of the rotary actuating element 39, the outer circumference 391 is axially moved into the first end face 101 along the longitudinal axis X. As shown in particular in FIG. 6, the outer circumference 391 is formed to be complementary to the square hollow cross section of the hollow carrier profile 10. In the locking position, the outer circumference 391 therefore interlockingly abuts the inner circumference 110 so as to rotate about the longitudinal axis X. The outer circumference 391 and the inner circumference 110 interact so as to be slidably movable along the longitudinal axis X.

In the embodiment shown, the rotary actuating element 39 is movable relative to the hollow carrier profile 10 along the longitudinal axis X. For this purpose, the rotary actuating element 39 is axially movably connected to the shaft 31. For the purposes of being axially movably connected to the shaft 31, the rotary actuating element 39 comprises an inner profile (no reference sign), which interacts with an outer profile 38, which is rigidly connected to the shaft 31. In the embodiment shown, the outer profile 38 is constructed in the manner of a pinion. The inner profile of the rotary actuating element 39 is complementary thereto and is provided with teeth for conjoint rotation with the outer profile 38 about the longitudinal axis X.

The actuating apparatus also comprises a tension spring 37, which is connected to the shaft 31 at one end and to the rotary actuating element 39 at the other end. The tension spring 37 loads the rotary actuating element 39 along the longitudinal axis X toward the first end face 101. In other words, the rotary actuating element 39 is axially pre-loaded toward its second position and/or into the first end face 101 (FIGS. 7 and 8) by means of the tension spring 37. To shift toward the first position (FIGS. 9 and 10), the rotary actuating element 39 needs to be pulled counter to a tensile force of the tension spring 37.

The functioning of the trailer hitch device 1 and its operation during mounting on the profile receptacle 1000 can be described as follows:

Before being inserted into the profile receptacle 1000, the trailer hitch device 1 is in the configuration shown in FIGS. 3, 4, 7, 8, and 12. In this configuration, the locking bolts 20, 21 assume the locking position. The rotary actuating element 39, the first arresting element 50, and the trigger element 51 each assume their second position. The rotary actuating element 39 is releasably arrested to the first end face 101 in the above-mentioned manner, by the outer circumference 391 interlockingly interacting with the inner circumference 110 in the rotational direction.

To shift the locking bolts 21, 21′ into the release position, the rotary actuating element 39 is axially pulled out of the hollow carrier profile 10 counter to the tensile force of the tension spring 37, such that the outer circumference 391 protrudes axially out of the inner circumference 110. As a result, the arresting of the rotational movability of the rotary actuating element 39 is released. The rotary actuating element 39 is then rotated clockwise about the longitudinal axis X. The rotational movement is transmitted to the locking bolts 21, 21′ and also to the leg spring 42 by means of the shaft 31 via the transmission 60. The leg spring 42 is thus loaded and generates a torque that acts counter to the rotational direction of the rotary actuating element 39. The torque of the leg spring 42 pre-loads the locking bolts 21, 21′ toward the locking position.

As the rotary actuating element 39 is shifted into its first position, the first arresting element 50 is axially pre-loaded into the first arresting portion 301 via the arresting spring 54, with the trigger element 51 simultaneously being moved from its second position into the first position. The trailer hitch device 1 is then in the configuration shown in FIGS. 9 and 10.

For the purposes of mounting on the motor vehicle, the hollow carrier profile 10 is positioned on the profile receptacle 1000 with its second end face 102 at the front and is axially inserted into its receiving cutout 1003. Once the hollow carrier profile 10 has been inserted far enough into the profile receptacle 1000, the contact surface 511 of the trigger element 51 comes into contact with the leading edge 1002 and is pushed into its second position starting from its first position. By means of the movement of the trigger element 51, the first arresting element 50 is pulled out of the first arresting portion 301 at the end face via the coupling rod 53. As a result, the arresting of the rotational movability of the rotary actuating element 39 is released, as a result of which the leg spring 42 pushes the locking bolts 21, 21′ toward the locking position via the shaft 31 and the transmission 60. During axial insertion, the locking bolts 21, 21′ slide outward along the profile receptacle in a pre-loaded manner until the locking openings 1001, 1001′ are reached. When they reach the locking openings 1001, 1001′, the locking bolts 21, 21′ are fully moved into the locking position by the pre-loading of the leg spring 42, with the rotary actuating element 39 also simultaneously being rotated into its second position and being axially pulled into the first end face 101 via the tension spring 37, as a result of which the outer circumference 391 in turn interlockingly interacts with the inner circumference 110.

The trailer hitch device 1 is unlocked and detached in the kinematically reverse manner.

FIG. 13 to 16 show alternatively constructed transmissions 60a, 60b for transmitting movement to the locking elements 20, 20′. The transmissions 60a, 60b are to be understood as variants of the transmission 60.

The transmission 60a according to FIGS. 13 and 14 comprises a gear stage comprising pinions 615a, 616a. In addition, a threaded stage is provided, which is formed by an element having an outer thread and an inner thread formed on the locking elements 20, 20′. The gear stage is driven by a bevel gear arranged at the end face of the shaft 31a. The gear stage drives the threaded stage. In the variant according to FIGS. 13 and 14, the transmission 60a therefore comprises a gear train 61a and a screw drivetrain 62a.

The transmission 60b shown in FIGS. 15 and 16 likewise comprises a gear train 61b and a screw drivetrain 62b. The gear train 61b comprises bevel gears (no reference sign), which are arranged at one end of the shaft 31b and at the end face of the locking elements 20, 20′ and are interlocked with one another. Each outer thread element, which is movable in a screwed manner relative to an inner thread of the relevant locking element 20, 20′, is rigidly connected to the bevel gears of the locking elements 20, 20′. The screw elements are translationally fixed. When the screw elements rotate, the locking elements 20, 20′ are screwed inward and/or outward.

1. A detachable trailer hitch device for a motor vehicle, comprising:
a hollow carrier profile extending longitudinally along a longitudinal axis and configured to be axially inserted into a profile receptacle fixed to the vehicle;
a hitch ball arranged on the hollow carrier profile and configured for coupling to a trailer hitch;
at least one locking element configured for releasably locking the hollow carrier profile to the profile receptacle fixed to the vehicle, the locking element being mounted on the hollow carrier profile and movable relative to the hollow carrier profile between a release position, in which release position the locking element is shifted into the hollow carrier profile transversely to the longitudinal axis, and a locking position, in which locking position the locking element protrudes out of the hollow carrier profile transversely to the longitudinal axis; and
an actuating apparatus having an actuating element operatively connected to the locking element, mounted on the hollow carrier profile, and manually movable relative to the hollow carrier profile,
wherein, through a movement of the actuating element the locking element is movable between the release position and the locking position.

2. The detachable trailer hitch device according to claim 1, further comprising at least one pre-loading element operatively connected to the locking element and/or the actuating apparatus, wherein the pre-loading element causes the locking element to be pre-loaded toward the locking position.

3. The detachable trailer hitch device according to claim 1, further comprising an arresting apparatus, the arresting apparatus releasably arresting the locking element in the release position and/or the locking position.

4. The detachable trailer hitch device according to claim 3, wherein the arresting apparatus comprises a first arresting element operatively connected to the locking element and/or the actuating apparatus in the release position of the locking element, the first arresting element causing the locking element to be releasably arrested in the release position.

5. The detachable trailer hitch device according to claim 4, wherein the actuating element includes a first arresting portion, the first arresting element releasably interlockingly interacting with the first arresting portion of the actuating element in the release position.

6. The detachable trailer hitch device according to claim 4, wherein the arresting apparatus comprises a trigger element operatively connected to the first arresting element, the trigger element being mounted on the hollow carrier profile so as to be movable between a first position and a second position and assuming the first position in the release position of the locking element, wherein a movement of the trigger element from the first position into the second position causes the arresting of the first arresting element to be released.

7. The detachable trailer hitch device according to claim 6, wherein the trigger element is movable from the first position into the second position under an action of the profile receptacle including axially inserting the hollow carrier profile into the profile receptacle.

8. The detachable trailer hitch device according to claim 6, wherein the trigger element protrudes out of the hollow carrier profile transversely to the longitudinal axis in the first position and is shifted into the hollow carrier profile in the second position.

9. The detachable trailer hitch device according to claim 4, wherein the arresting apparatus comprises a second arresting element operatively connected to the locking element and/or the actuating apparatus in the locking position of the locking element, wherein the second arresting element causes the locking element to be releasably arrested in the locking position.

10. The detachable trailer hitch device according to claim 9, wherein the actuating element includes a second arresting portion, the second arresting element is formed by a portion of the hollow carrier profile, the second arresting element releasably interlockingly interacting with the second arresting portion of the actuating element in the locking position.

11. The detachable trailer hitch device according to claim 1, wherein the actuating apparatus comprises a transmission connecting the actuating element to the locking element for the transmission of movement.

12. The detachable trailer hitch device according to claim 11, wherein the transmission is configured to convert a rotational movement of the actuating element into a translational movement of the locking element.

13. The detachable trailer hitch device according to claim 11, wherein the transmission comprises a gear train and/or a screw drivetrain.

14. The detachable trailer hitch device according to claim 1, wherein the actuating element comprises a rotary actuating element, the rotary actuating element being manually rotatably movable relative to the hollow carrier profile.

15. The detachable trailer hitch device according to claim 14, wherein the hollow carrier profile comprises an end face and the rotary actuating element is arranged on the end face of the hollow carrier profile and is rotatably movable about the longitudinal axis.

16. The detachable trailer hitch device according to claim 15, wherein an outer circumference of the rotary actuating element is moved into the end face of the hollow carrier profile along the longitudinal axis in the locking position and interlockingly abuts an inner circumference of the end face so as to rotate about the longitudinal axis, and the rotary actuating element is moved out of the end face along the longitudinal axis in the release position.

17. The detachable trailer hitch device according to claim 1, wherein the locking element comprises a locking bolt translationally movable relative to the hollow carrier profile.

18. The detachable trailer hitch device according to claim 1, wherein the at least one locking element comprises two locking elements arranged on opposite longitudinal sides of the hollow carrier profile and movable in opposite directions from one another.

19. A motor vehicle comprising:
a profile receptacle fixedly arranged on a rear of the vehicle; and
a detachable trailer hitch device, the detachable trailer hitch device comprising:
a hollow carrier profile extending longitudinally along a longitudinal axis and configured to be axially inserted into the profile receptacle fixed to the vehicle;
a hitch ball arranged on the hollow carrier profile and configured for coupling to a trailer hitch;
at least one locking element configured for releasably locking the hollow carrier profile to the profile receptacle fixed to the vehicle, the locking element being mounted on the hollow carrier profile and movable relative to the hollow carrier profile between a release position, in which release position the locking element is shifted into the hollow carrier profile transversely to the longitudinal axis, and a locking position, in which locking position the locking element protrudes out of the hollow carrier profile transversely to the longitudinal axis; and
an actuating apparatus having an actuating element operatively connected to the locking element, mounted on the hollow carrier profile, and manually movable relative to the hollow carrier profile, wherein, through a movement of the actuating element the locking element is movable between the release position and the locking position.

20. The detachable trailer hitch device according to claim 8, wherein the trigger element comprises a contact surface configured to interact with the profile receptacle.
